(19) United States
(12) Patent Application Publication
(10) Pub. No.: US 2004/0165009 A1
(43) Pub. Date: Aug. 26, 2004

(54) Expansion of interactive user interface components

(75) Inventors: Jason Yi Blakely, Cary, NC (US); Robert Selby Sielken, Chapel Hill, NC (US)

Correspondence Address: CHRISTOPHER & WEISBERG, P.A., 200 EAST LAS OLAS BOULEVARD, SUITE 2040, FORT LAUDERDALE, FL, 33301, US

(73) Assignee: International Business Machines Corporation, Armonk, NY

(21) Appl. No.: 10/370,539

(22) Filed: Feb. 20, 2003

(51) Int. Cl. G09G 5/00

(52) U.S. Cl. 345/801; 345/826

(57) ABSTRACT

An expandable interactive user interface component. A method for expanding an interactive user interface control in a window without affecting the interactivity of other user interface controls in the window can include detecting when the interactive user interface control has been activated. Responsive to the activation, the interactive user interface control can be drawn in the window in either an expanded, magnified, or both expanded and magnified mode without regard to whether the interactive user interface control in the expanded mode obscures some of the other user interface controls. Finally, user interactivity can be accepted both in the interactive user interface control which has been expanded, and in the other user interface controls, regardless of the mode of the expandable interactive user interface component.

### BACKGROUND OF THE INVENTION

1. Statement of the Technical Field

The present invention relates to the field of user interface controls and more particularly, to the disposition of an expandable user interface control in a user interface window.

2. Description of the Related Art

The conventional graphical user interface (GUI) has been widely used for many years. The primary function of the GUI includes providing user interface controls with which the end-user can interact with an underlying application. The common GUI includes many stock user interface controls, most of which, when combined, can accommodate most computer-human interactions required by an application. For example, when disposed in a window such as a dialog box, the static text box control can be used to present text to the end-user while an edit box can permit the user to provide textual input to the application. A radio button control can provide for the exclusive selection of an element from among a field of elements, while a checklist box can provide for the non-exclusive selection of elements from among a field of elements.

Display space within a window has always been recognized as a design problem in the development of a user interface for an application. Specifically; many have previously lamented that the disposition of interactive user interface controls in a window can be viewed as a “zero sum game”. Namely, to enlarge one user interface control in a window will cause a like shrinkage in another user interface control in the same window. Hence, heretofore user interface designers have been limited in the number, nature and size of interactive user interface controls which can be disposed in any given window.

To that end, several user interface strategies have been utilized to circumvent the zero sum game problem. For instance, tabbed displays in which different displays can be arranged in tabbed order, while only one tab is displayed at once, have been helpful where a composite user interface can be neatly and logically subdivided into units suitable for display in association with separate tabs of the display. Still, where a user interface cannot be logically divided into compartmentalized tabbed displays, this approach has proven inadequate.

Alternatively, a user interface has been configured with both a condensed and detailed arrangement. In the detailed portion of the user interface, controls disposed therein can be manipulated at will. In contrast, in the condensed portion of the user interface user interface controls are read-only in that the end user can only interact with controls in the detailed portion of the user interface. In a similar vein, it has long been known to graphically enlarge a portion of a window on command where such portion contains merely read only content such as imagery. In both cases, however, the controls in the window, whether enlarged or condensed, cannot equally function as conventional controls. Rather, in the former circumstance, only the enlarged element can remain interactive, while in the latter circumstance, only the non-enlarged elements can remain interactive. In neither case will all interactive elements in the window remain interactive.

Most have addressed the zero sum game problem simply by compressing the size of the individual interactive user interface controls in a window. FIG. 1 is a pictorial illustration of an exemplary dialog box which can be instructive in this regard. Referring to FIG. 1, a conventional dialog box 100 can include any number of both read only and interactive user interface controls. By read only it is meant that the control is meant for display only and can provide no possibility for user interaction. An example of a read only type control can include the static text controls 110 of FIG. 1. Interactive user interface controls, by comparison, can permit user interaction and can include, by way of example, an edit box 120, a drop down box 130, buttons 140, a selection box 150, check box controls 160 (whether or not disposed in a selection box), and radio buttons 170.

In any case, to satisfactorily position each user interface control in the dialog box 100, certain controls have been compressed in size such as the selection box 150 containing the selection of check box controls 160. While the selection box 150 can remain interactive notwithstanding its compression, little of the selection can be displayed as most of the selection of check box controls 160 will be obscured by the small size of the selection box 150 itself. Accordingly, though all of the desired controls can be accommodated in the exemplary dialog box 100 of FIG. 1, at least the selection box 150 has been so compressed that it functions poorly as an interactive user interface control.

### SUMMARY OF THE INVENTION

The present invention is a method and system for expanding interactive user interface controls in a user interface which circumvents the foregoing limitations associated with the zero sum game of the user interface while overcoming the deficiencies of known prior art solutions to the zero sum game problem. Specifically, in accordance with the inventive arrangements, individually selectable user interface controls which are interactive in nature can be enlarged and repositioned in the user interface when selected. Other controls in the user interface can remain interactive as well, though the other controls will remain in a default state.

Significantly, while enlarged, the user interface control can remain interactive as can those controls in the user interface which have not been enlarged. In this way, an enlarged user interface control of interest can be accessed in an interactive manner without prejudicing the ability for other user interface controls to receive focus and to provide for end user interaction. Furthermore, the enlarged user interface control will not be restricted in size to its default allocated portion. Rather, the enlarged user interface control can consume as much as the entire display space available in the window, though such enlargement can obscure other user interface controls in the display.

The present invention can include an expandable user interface component article of manufacture. The article of manufacture can include an expanded state and a compacted or collapsed state in which the expandable user interface component can remain interactive regardless of whether the component is in the expanded state or the compacted state. The article of manufacture further can include logic for determining whether the component has been selected, responsive to which the user interface component can toggle between the expanded state and the compacted state. Finally, the article of manufacture can include an interface to the expandable user interface component. The interface itself can have a configuration for integration in a conventional window without respect to the expanded state and the compacted state. Notably, the expanded state can include either a magnified state or an enlarged, but unmagnified state.

The present invention further can include a method for expanding an interactive user interface control in a window without affecting the interactivity of other user interface controls in the window. The method can include detecting when the interactive user interface control has been activated. Responsive to the activation, the interactive user interface control can be drawn in the window in an expanded mode without regard to whether the interactive user interface control in the expanded mode obscures some of the other user interface controls. Finally, user interactivity can be accepted both in the interactive user interface control which has been expanded, and in the other user interface controls.

### BRIEF DESCRIPTION OF THE DRAWINGS

There are shown in the drawings embodiments which are presently preferred, it being understood, however, that the invention is not limited to the precise arrangements and instrumentalities shown, wherein:

FIG. 1 is a pictorial illustration of an exemplary dialog box known in the art;

FIG. 2 is a pictorial illustration of a dialog box configured with an expandable user interface component in accordance with one aspect of the inventive arrangements;

FIG. 3 is a pictorial illustration of a dialog box configured with an expandable user interface component in accordance with another aspect of the inventive arrangements; and,

FIG. 4 is a flow chart illustrating a process for expanding and collapsing an interactive user interface control in accordance with the inventive arrangements.

### DETAILED DESCRIPTION OF THE PREFERRED EMBODIMENTS

The present invention is a system and method for expanding and collapsing selected interactive user interface controls in a window of a user interface. Importantly, when expanded, the selected user interface control can remain interactive. Concurrently, those user interface controls which have not been selected also can remain interactive as the case may be. In this way, those who interact with a user interface which has been configured with an expandable interactive user interface component can enjoy the ease of interaction associated with a full size control while not statically prejudicing the size or placement of other controls in the user interface.

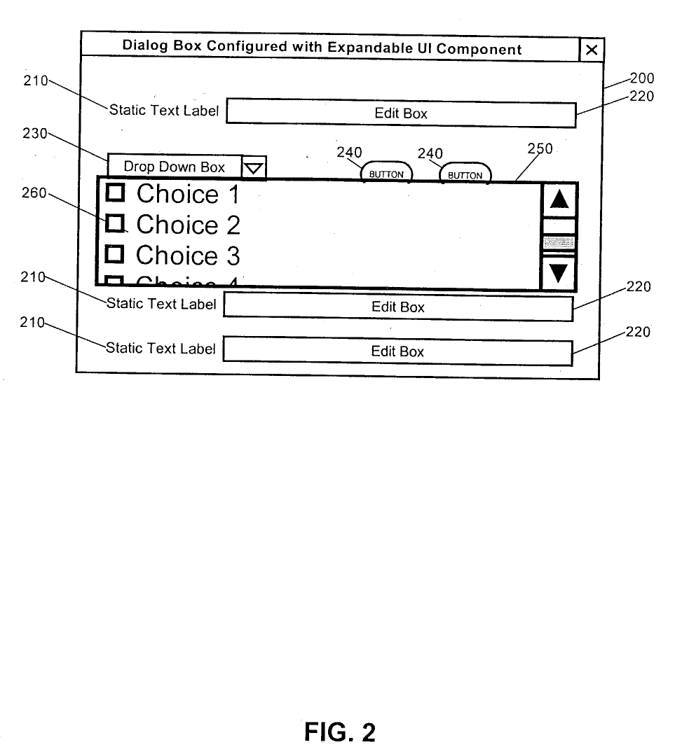

FIG. 2 is a pictorial illustration of a dialog box which has been configured with an expandable user interface component in accordance with one aspect of the inventive arrangements. The dialog box 200 can include both interactive and non-interactive controls. Non-interactive controls can include static text fields 210, while interactive controls can include edit boxes 220, drop-down boxes 230, buttons 240, selection boxes 250 and checkbox controls 260. It will be recognized by the skilled artisan that the exemplary dialog box 200 includes a selection box 250 having individual checkbox controls 260 forming the set of selections in the selection box 250.

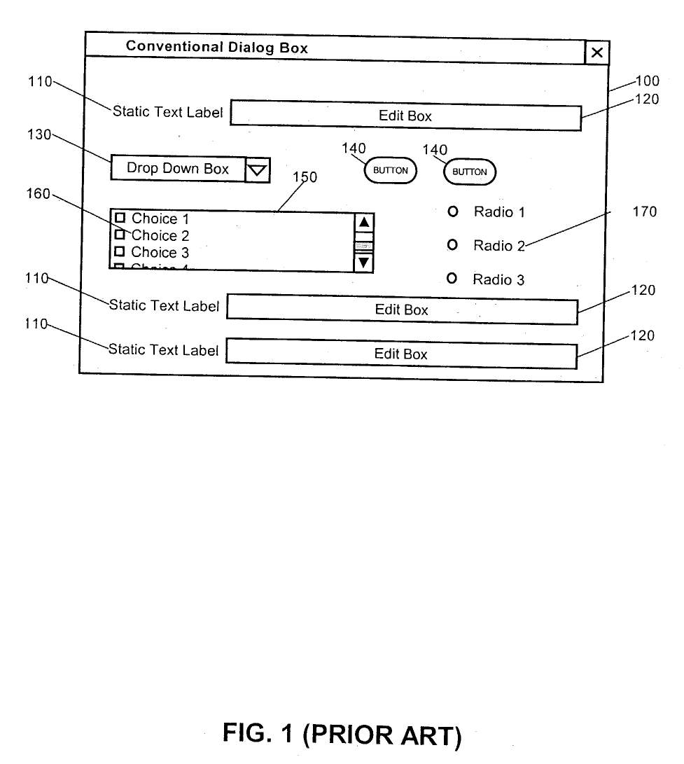

In any event, while the selection box 250 can be sized in a default position similar to the position of the selection box 150 of FIG. 1, when selected, the selection box 250 can be expanded to its shown size. Importantly, the selection box 250 can be expanded, even so as to obscure other controls 210, 220, 230, 240. Specifically, in the circumstance illustrated in FIG. 2, the selection box 250 can be magnified so as to be more easily seen in the dialog box 200. Yet, the selection box 250 can remain fully interactive as can those controls 220, 230, 240 which are not expanded.

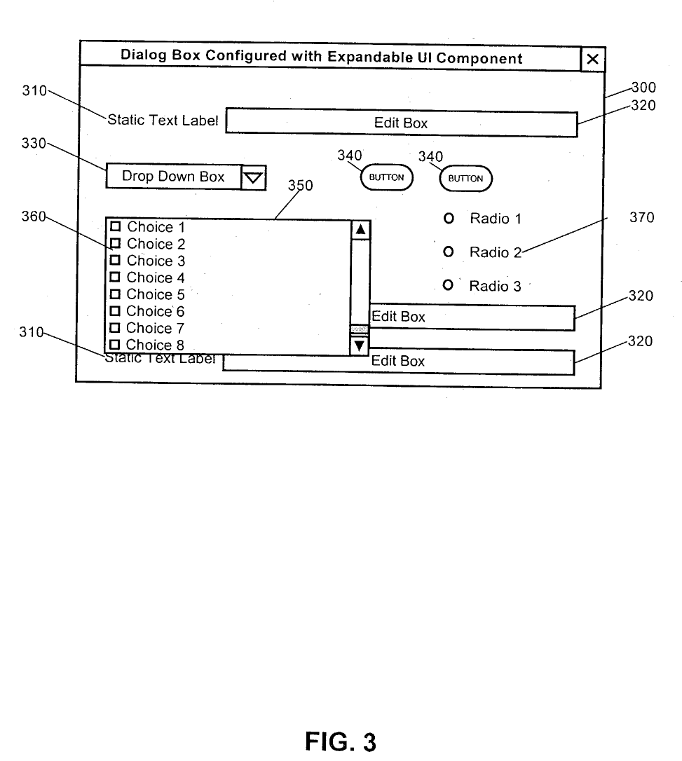

The present invention is not limited, however, to the mere magnification of a selected interactive user interface control as shown in FIG. 2. Rather, other forms of expansion are contemplated to fall within the scope of the invention as well. For instance, FIG. 3 is a pictorial illustration of a dialog box configured with an expandable user interface component in accordance with another aspect of the inventive arrangements. In FIG. 3, the expandable user interface component can be maximized in size without magnifying the resolution of the control. In this regard, to the extent that the compacted default display of the user interface control obscures a portion of the user interface control as shown in FIG. 3, the user interface control can be expanded so that all of the user interface control can be viewed and accessed.

With particular reference to FIG. 3, a dialog box 300 can be configured to include both interactive and non-interactive controls. Non-interactive controls can include static text fields 310, while interactive controls can include edit boxes 320, drop-down boxes 330, buttons 340, selection boxes 350, checkbox controls 360 and radio buttons 370. As before, in reference to FIG. 3 it will be recognized by the skilled artisan that the exemplary dialog box 300 includes a selection box 350 having individual checkbox controls 360 forming the set of selections in the selection box 350.

In any event, while the selection box 350 can be sized in a default position similar to the position of the selection box 150 of FIG. 1, when selected, the selection box 350 can be expanded to its shown size. Importantly, the selection box 350 can be expanded, even so as to obscure other controls 310, 320, 330, 340, 370. Specifically, in the circumstance illustrated in FIG. 3, the selection box 350 can be expanded to a maximum size without magnifying the resolution of the selection box control 350. In consequence, an end user interacting with the selection box 350 can view the entire range of checkbox controls 360 disposed in the selection box 350 without requiring the use of a scroll bar.

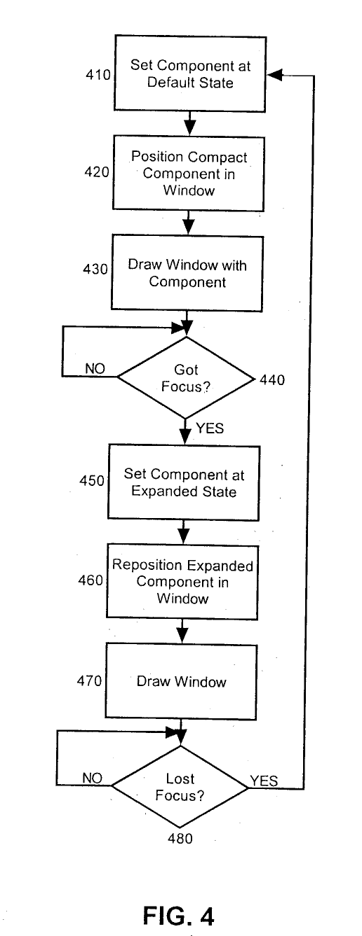

FIG. 4 is a flow chart illustrating a process for expanding and compacting an interactive user interface control in accordance with the inventive arrangements. Beginning in block 410, the expandable interactive user interface component can be sized at its default, compacted state. In block 420, the expandable interactive user interface component can be positioned in a window of a user interface and in block 430 the window can be displayed in the user interface. In decision block 440, the window can remain displayed as configured until the expandable interactive user interface component is activated. By activated, it is meant that the component can any one of selected with a mouse or keyboard event, or other user input device event. The activation can range from a mere acquisition of focus, to a physical mouse click about the component, and the invention is not so limited to the precise manner in which the component is activated.

In block 450, once activated, the interactive user interface component can be modified to an expanded state. An expanded state can include, but is not limited to a magnified state of higher resolution, both a magnified state of higher resolution and an enlarged size, or simply an enlarged size at the same resolution as the default state so as to show more of the control. The latter expanded state can be helpful in such circumstances where portions of the control can be viewed only through the activation of a scroll bar control included as part of the interactive user interface control. In such cases, the larger the interactive user interface control, the less likely it will be that the activation of the scroll bar control will be required to view the interactive user interface control in its entirety.

Importantly, in all cases, in block 460 the expanded user interface control can be positioned in the window regardless of the presence of surrounding user interface controls. To that end, the expanded user interface control can be overlain atop the surrounding user interface controls in the same manner that a tool tip can obscure adjacent controls. In any event, once positioned, in block 470 the window can be re-drawn to show the newly expanded user interface control. The expanded user interface control can remain displayed until in decision block 480 it is determined that the expanded user interface control no longer is activated. In this case, the window can be re-drawn with the expanded user interface control being returned to a compacted, default state.

The expandable user interface control of the present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. An expandable user interface component article of manufacture comprising:
an expanded state and a compacted state in which the expandable user interface component can remain interactive regardless of whether the component is in said expanded state or said compacted state;
logic for determining whether said component has been activated, responsive to which said user interface component can toggle between said expanded state and said compacted state; and,
an interface to the expandable user interface component, said interface having a configuration for integration in a conventional window without respect to said expanded state and said compacted state.

2. The expandable user interface component of claim 1, wherein said expanded state comprises a state selected from the group consisting of a magnified state, an enlarged, but unmagnified state, and an enlarged and magnified state.

3. A method for expanding an interactive user interface control in a window without affecting the interactivity of other user interface controls in the window, the method comprising the steps of:
detecting when the interactive user interface control has been activated;
responsive to said activation, drawing the interactive user interface control in the window in an expanded mode without regard to whether said interactive user interface control in said expanded mode obscures some of the other user interface controls; and,
accepting user interactivity both in said interactive user interface control which has been expanded, and in the other user interface controls.

4. The method of claim 3, wherein said step of detecting comprises the step of detecting one of a received focus event, a mouse selection event, and a keyboard selection event.

5. The method of claim 3, wherein said step of drawing comprises the step of drawing the interactive user interface control in the window in a magnified mode without regard to whether said interactive user interface control in said magnified mode obscures some of the other user interface controls.

6. The method of claim 3, wherein said step of drawing comprises the step of drawing the interactive user interface control in the window in an enlarged, unmagnified mode without regard to whether said interactive user interface control in said enlarged, unmagnified mode obscures some of the other user interface controls.

7. The method of claim 3, wherein said step of drawing comprises the step of drawing the interactive user interface control in the window in an enlarged and magnified mode without regard to whether said interactive user interface control in said enlarged and magnified mode obscures some of the other user interface controls.

8. The method of claim 3, further comprising the steps of:
further detecting when the interactive user interface control in said expanded mode has been deactivated;
responsive to said deactivation, drawing the interactive user interface control in the window in a compacted, default mode; and,
accepting user interactivity both in said interactive user interface control which has been compacted, and in the other user interface controls.

9. A machine readable storage having stored thereon a computer program for expanding an interactive user interface control in a window without affecting the interactivity of other user interface controls in the window, the computer program comprising a routine set of instructions for causing the machine to perform the steps of:
detecting when the interactive user interface control has been activated;
responsive to said activation, drawing the interactive user interface control in the window in an expanded mode without regard to whether said interactive user interface control in said expanded mode obscures some of the other user interface controls; and,
accepting user interactivity both in said interactive user interface control which has been expanded, and in the other user interface controls.

10. The machine readable storage of claim 9, wherein said step of detecting comprises the step of detecting one of a received focus event, a mouse selection event, and a keyboard selection event.

11. The machine readable storage of claim 9, wherein said step of drawing comprises the step of drawing the interactive user interface control in the window in a magnified mode without regard to whether said interactive user interface control in said magnified mode obscures some of the other user interface controls.

12. The machine readable storage of claim 9, wherein said step of drawing comprises the step of drawing the interactive user interface control in the window in an enlarged, unmagnified mode without regard to whether said interactive user interface control in said enlarged, unmagnified mode obscures some of the other user interface controls.

13. The machine readable storage of claim 9, wherein said step of drawing comprises the step of drawing the interactive user interface control in the window in an enlarged and magnified mode without regard to whether said interactive user interface control in said enlarged and magnified mode obscures some of the other user interface controls.

14. The machine readable storage of claim 9, further comprising the steps of:
further detecting when the interactive user interface control in said expanded mode has been deactivated;
responsive to said deactivation, drawing the interactive user interface control in the window in a compacted, default mode; and,
accepting user interactivity both in said interactive user interface control which has been compacted, and in the other user interface controls.
